(19) United States
(12) Patent Application Publication
(10) Pub. No.: US 2006/0248040 A1
(43) Pub. Date: Nov. 2, 2006

(54) System and method for adaptive remote file caching

(75) Inventors: Jarkko Tolvanen, Helsinki (FI); Jaakko Lipasti, Jorvas (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/119,628

(22) Filed: May 2, 2005

(51) Int. Cl. G06F 17/30

(52) U.S. Cl. 707/1; 711/118

(57) ABSTRACT

A system and method for caching the results of various operations on a remote or distributed file system. The present invention takes into account the MIME type or other file type for a particular file and the application being used to open the file in order to determine whether the entire file should be cached, or whether only the metadata-portion of the file should be cached.

### FIELD OF THE INVENTION

The present invention relates generally to remote file caching. More particularly, the present invention relates to systems for remote file caching that can take advantage of traditional benefits of both whole file caching and partial file caching.

### BACKGROUND OF THE INVENTION

A client in a remote or distributed file system typically caches the results of various operations, such as “read” and “write” operations. Caching involves the downloading of material that is subject to a particular operation. Caching is often based on fixed size blocks, such as in a network file system (NFS) or in a server message block (SMB)/common internet file system (CIFS) systems. When a client needs data, a file block containing that data is cached. This is referred to as “block caching.” Other blocks of the same file remain remote. Some remote file systems, such as Andrew File System, Version 2 (AFS2) and Coda systems, use whole file caching. With whole file caching, the entire file is instantly cached when it is first opened.

In mobile electronic devices, remote file system clients cannot assume that there will always be a good connection to an associated server. For example, if a particular device has wireless local area network (WLAN) and cellular connections, the WLAN is usually available only at WLAN hotspots, and the user may not be willing to allow the client to use the cellular connection in certain locations due to monetary factors or other issues. Because there may not always be a solid connection between a client and a server, the remote file system client should allow for disconnected operation, where the client is able to use all of the remote files that are locally cached without maintaining a connection to the server. One of the requirements for general purpose disconnected operation is whole file caching. A benefit of disconnected operation is that several over-the-network read requests are not required to obtain the file data. This can be important in cellular networks, such as general packet radio service (GPRS) networks. Typically, latency is high in such networks, meaning that it can take a considerable amount of time for data to be transmitted to the client. It is therefore preferable if multiple read requests are not required.

Because of the disconnected operation requirement, whole file caching is often preferable over block caching. However, if whole file caching is the only method of file caching that is used, the whole file must be immediately fetched in order to serve any read request. For example, in a Symbian smart phone, some applications may have to obtain pre-file metadata information when displaying a directory listing. This can result in substantial and often unacceptable delays as all of the directory contents are fetched.

In the client device, a file might be needed for one of two purposes: to display metadata contained in the file itself or to consume the actual file data (the “real” data) in some manner. For example, an MP3-player may wish to build a list of MP3 songs available from the remote server, including information such as the artist's name, the album name and the name of the song, which are available in ID3v2 tags at the beginning of the file (these tags can also be located at the end of the file). Alternatively, the MP3 player may want to play the song and therefore will need the actual file data.

In an exemplary current implementation of caching, caching may occur in two phases: either the metadata is cached and is available when the client is disconnected from the server, or the entire file is cached and is available when the client is disconnected from the server. However, no matter which file caching system is used, the same problem persists. Typically, whole file caching is desired because of its inherent support for a client's disconnected mode, but for performance reasons, partial or block caching is often preferred to address the issues discussed above. In order to support both types of caching in the same system, a system would therefore be needed for determining which type of caching is required.

### SUMMARY OF THE INVENTION

The present invention provides for a system and method by which an electronic device can obtain the benefits of both partial file caching and whole file caching. By examining the read request and by knowing something about the file's type and its consuming application, a cutoff threshold can be determined. The electronic device can use this threshold to determine when partial file caching should be used and when whole file caching should be used.

The present invention provides for a number of benefits that cannot typically be achieved with conventional systems. With the present invention, the electronic device can enter a disconnected mode any time, and the device can possess a coherent cache where each file (1) is not cached; (2) has the in-file metadata cached, allowing the device to exhibit the file on different lists or (3) has the entire file cached, allowing the complete use of the file while the device is in the disconnected mode.

Furthermore, in order to accommodate high-latency networks, the whole metadata can be fetched from the server in a single read as soon as it is determined that the whole metadata is needed. For example, a conventional MP3-player may perform three reads: one for the artist's name, a second for the album name, and a third for the song name. With the present invention, however, only one read request has to be sent to the server, allowing the device to obtain the required metadata more quickly.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2; and

FIG. 4 is a flow chart showing the implementation of one embodiment of the present invention.

### DETAILED DESCRIPTION OF THE PREFERRED EMBODIMENTS

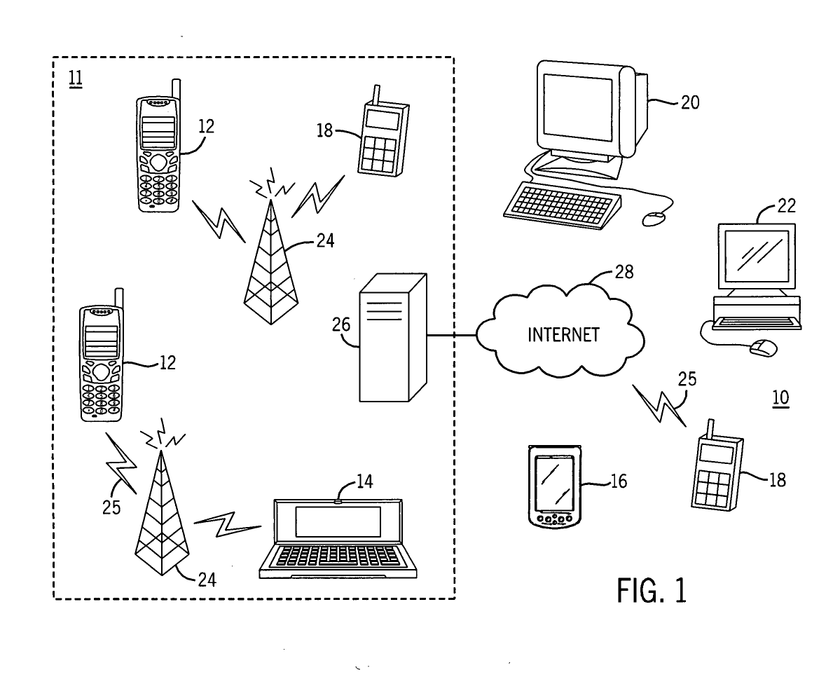

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

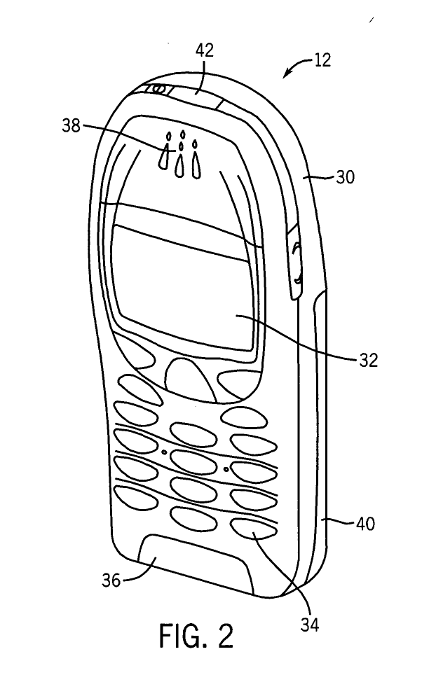

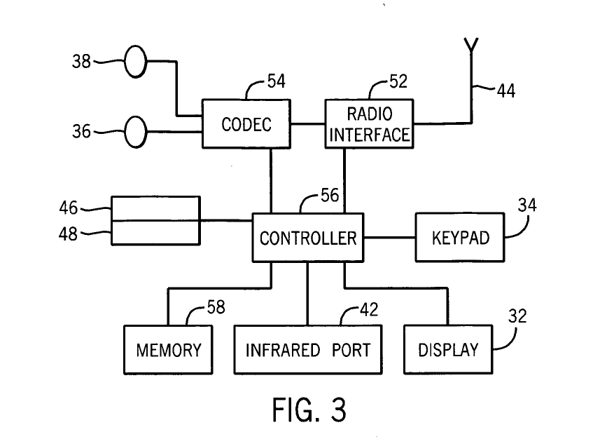

FIGS. 2 and 3 show one representative mobile telephone 12 within which the present invention may be implemented. This mobile telephone 12 can serve as a client terminal or a server depending upon the particular system at issue. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

As discussed above, the present invention provides for a remote file access framework that combines the beneficial properties of both partial or block file caching and whole file caching. Based on the file type, such as the multipurpose Internet mail extension (MIME) type, and the behavior of the device application consuming that particular file type, the entire metadata portion of the file is first cached on the client terminal. Subsequently, if data beyond the metadata is requested, the whole data portion of the file is then cached.

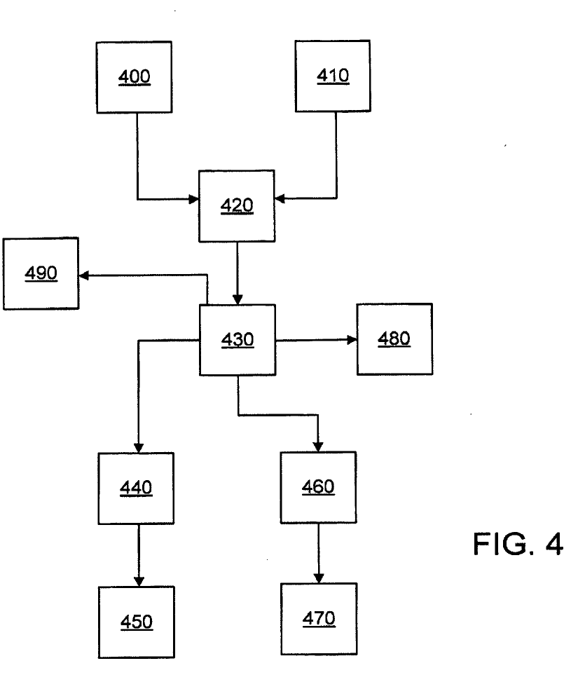

FIG. 4 shows the steps involved in the implementation of one particular embodiment of the present invention. FIG. 4 is discussed in terms of the mobile telephone 12 serving as the client terminal which is caching information from the server 26, both of which are depicted in FIG. 1. However, it should be understood that the invention is not limited to any type of electronic device, server, or arrangement of such devices.

At step 400 in FIG. 4, the mobile telephone 12 typically observes the MIME type of each file when directory attributes are fetched from the server 26. It should be noted that, although this particular example refers to the MIME type of each file, the present invention can also be applied to other file type standards. An integer limit value is assigned at step 420. The integer limit value is based in large part on the MIME type of the file. The integer limit value informs the mobile telephone 12 how many bytes from the beginning of the file are assumed to be metadata, as well as the location where the actual file data begins. This value is read from a configuration file in the mobile telephone 12. It should be noted that, under some circumstances, it may be necessary to adjust this value “on the go.” For example, ID3v2-tags are intended to be flexible and expandable. Each frame can be 16 MB in size, and the entire tag can be 256 MB in size. Although these tags are usually significantly smaller than these maximum values and their length can be predicted, applications may use tags with large variation in length. In such a situation, the beginning of the tag can be examined to see the length and to adjust the threshold value. In this situation, two reads would be required in obtaining the metadata: a first, “best guess” read based on the configuration file and a second read to obtain all of metadata.

If the server 26 does not immediately recognize the MIME type (i.e., the MIME type is not determined when the mobile telephone 12 reads the directory properties), the mobile telephone 12 can request this information from the Symbian recognizer framework after fetching the first 128 first bytes. This step is represented at step 410. A Symbian recognizer is a mechanism used in Symbian technology for determining the file's MIME type so that, for example, an icon can be set in a file browser. With this information, the integer limit value can therefore be set.

In addition to the MIME-type, the behavior of the application for the particular MIME type is considered in setting the integer limit value. For example, a MP3 tag (also referred to as an ID3 tag) can theoretically be of an arbitrary length. However, it is known that the Nokia 9500 Media Player application reads about the first 8000-9000 bytes of a file in order to locate the metadata. Therefore, this factor is also considered by the mobile telephone 12, and an integer limit value of 10,000 bytes may be appropriate for a file being read by this particular application. A configuration file stored on the mobile telephone 12 can be used to easily tune the appropriate limit value for that particular device.

In one embodiment of the present invention, the system may adapt to typical read behavior for particular file types, either automatically or with user assistance. In this embodiment, the need to specify a threshold cutoff may be avoided, although such a value could be used as a default value for user-assisted systems and as a starting point for automatic systems. The adaptation of read behavior may be implemented in various ways. For example, it may be carried out by using an average or median of a predefined amount of latest read times. A more sophisticated method, such as using a recursive running average with exponential forgetting, may also be used. An advantage of a more sophisticated method is that the reliability of the result may be estimated as well. The reliability may also be estimated through the calculation of variance in case average- or median-based methods. In one embodiment of the invention, if the reliability is found to be poor in the automatic adaptation for a particular file type, then the system may either use larger values than achieved with an adaptation mechanism, or it may switch itself to use a predefined value.

At step 430, the file is read. At this point, it is assumed that a “lastbyte” value represents the last byte requested by the application's “read” request. In this exemplary embodiment, the recognizer needs bytes 0-127 for various purposes. If the lastbyte value is less than 128, then a cutoff threshold is set at 127 at step 440, and bytes 0-127 are cached by the mobile telephone 12 at step 440. Bytes 0-127 are needed by Symbian recognizers for various purposes. For example, the recognizer might want to examine this file at a random time. For this reason, it does not make sense for the mobile telephone 12 to fetch less than the first 127 bytes. It also does not make sense for the mobile telephone to fetch more than 127 bytes in this case, as the recognizer may be the only application that is interested in the file.

If the lastbyte value is more than or equal to 127 but is less than the MIME type-specific threshold, then the cutoff threshold is set to the integer limit value at step 460. The mobile telephone 12 then attempts to cache the data up to the integer limit value with as few roundtrips as possible up to the MIME type specific threshold at step 470. In this situation, the MIME type of the file must be taken into account when deciding what the threshold should be. For example, if the file is a text file, the threshold can be set as low as 0 because the file does not include any metadata. If the file is a JPEG file (JFIF), the threshold can also be 0, meaning that the mobile device will fetch the entire file. In such case, the current image viewer in Series60 and Series80 smart phones does not use any metadata; it is therefore known that the image itself is being shown. On the other hand, if the file at issue is an MP3 file, the integer limit value may be 10,000. Although this may only be an estimate for the threshold, it should be sufficient for allowing an MP3-tag to be read. When Series 80 Media Player is reading beyond byte no. 10,000, it is known that the application is playing the actual song.

If the lastbyte value is greater than or equal to the integer limit value, then the whole file is cached at step 480. Alternatively, it is possible that, if the lastbyte value is equal to the integer limit value, only the portion of the file up to the lastbyte value is cached. By implementing the above steps, the mobile telephone 12 is able to cache entire files when necessary, while also only partially caching files when whole file caching is not necessary.

A number of MP3 players also routinely read the last 128 bytes of a file in order to obtain an ID3v1 tag, if such a tag exists in the file. With the present invention, it is undesirable for this request to trigger the fetching and caching of the entire file, as this particular process is only part of the metadata-reading phase. Therefore, at step 490 it is determined whether the first byte requested is larger than the last byte cached plus one. If so, then the requested data will be fetched but not cached. If the metadata is stored to an ID3v2 tag at the beginning of the file, then these last 128 bytes will not be needed at a later to present the metadata.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of caching information on an electronic device, comprising:
determining a file type for a file to be downloaded;
assigning an integer limit value for the file based at least partly upon the file type, the integer limit value corresponding to a particular byte number in the file;
reading the file up to a specified last byte of data, the last byte of data having a value corresponding to its position within the file;
if the value of the last byte of data is less than the integer limit value, caching a portion of the file up to the integer limit value; and
if the value of the last byte of data exceeds the integer limit value, caching the entire file.

2. The method of claim 1, wherein the integer value limit is also based at least partly upon the application to be used for reading the file.

3. The method of claim 1, wherein the determining of the file type includes requesting the file type of the file from a Symbian recognizer.

4. The method of claim 1, further comprising, if the value of the last byte of data is less than or equal to 127, caching only the first 128 bytes of the file.

5. The method of claim 1, wherein the integer value limit is based at least partly upon one of the group consisting of running average, recursive running average and median.

6. The method of claim 1, wherein the integer limit value is obtained from a configuration file stored in the electronic device.

7. The method of claim 1, further comprising, if the value of the last byte of data is equal to the integer limit value, caching the entire file.

8. The method of claim 1, further comprising, if the value of the last byte of data is equal to the integer limit value, caching a portion of the file up to the integer limit value.

9. The method of claim 1, further comprising, if the value of the first byte of data for the file to be downloaded is greater than the last byte plus one of data previously cached, not caching any portion of the file.

10. The method of claim 1, wherein the file type comprises a MIME type.

11. A computer program product for caching information on an electronic device, comprising:
computer code for determining a file type for a file to be downloaded;
computer code for assigning an integer limit value for the file based at least partly upon the file type, the integer limit value corresponding to a particular byte number in the file;
computer code for reading the file up to a specified last byte of data, the last byte of data having a value corresponding to its position within the file;
computer code for, if the value of the last byte of data is less than the integer limit value, caching a portion of the file up to the integer limit value; and
computer code for, if the value of the last byte of data exceeds the integer limit value, caching the entire file.

12. The computer program product of claim 11, wherein the integer value limit is also based at least partly upon the application to be used for reading the file.

13. The computer program product of claim 11, wherein the determining of the file type includes requesting the file type of the file from a Symbian recognizer.

14. The computer program product of claim 11, further comprising computer code for, if the value of the last byte of data is less than or equal to 127, caching only the first 128 bytes of the file.

15. The computer program product of claim 11, further comprising computer code for, if the value of the last byte of data is equal to the integer limit value, caching the entire file.

16. The computer program product of claim 11, further comprising computer code for, if the value of the last byte of data is equal to the integer limit value, caching a portion of the file up to the integer limit value.

17. The computer program product of claim 11, wherein the integer value limit is based at least partly upon one of the group consisting of running average, recursive running average and median.

18. An electronic device, comprising:
a processor; and
a memory unit operatively connected to the processor, the memory unit including:
computer code for determining a file type for a file to be downloaded;
computer code for assigning an integer limit value for the file based at least partly upon the file type, the integer limit value corresponding to a particular byte number in the file;
computer code for reading the file up to a specified last byte of data, the last byte of data having a value corresponding to its position within the file;
computer code for, if the value of the last byte of data is less than the integer limit value, caching a portion of the file up to the integer limit value; and
computer code for, if the value of the last byte of data exceeds the integer limit value, caching the entire file.

19. The electronic device of claim 18, wherein the integer value limit is also based at least partly upon the application to be used for reading the file.

20. The electronic device of claim 18, wherein the determining of the file type includes requesting the file type of the file from a Symbian recognizer.

21. The electronic device of claim 18, wherein the memory unit further includes computer code for, if the value of the last byte of data is less than or equal to 127, caching only the first 128 bytes of the file.

22. The electronic device of claim 18, wherein the memory unit further includes computer code for, if the value of the last byte of data is equal to the integer limit value, caching a portion of the file up to the integer limit value.

23. The electronic device of claim 18, wherein the integer value limit is based at least partly upon one of the group consisting of running average, recursive running average and median.
